(19) United States
(12) Patent Application Publication
(10) Pub. No.: US 2022/0195926 A1
(43) Pub. Date: Jun. 23, 2022

(54) FUEL SUPPLY SYSTEM OF A TURBOMACHINE, WITH REGULATION OF THE FUEL FLOW

(71) Applicant: SAFRAN AIRCRAFT ENGINES, Paris (FR)

(72) Inventors: Loic PORA, Moissy-Cramayel (FR); Huguette DE WERGIFOSSE, Moissy-Cramayel (FR)

(21) Appl. No.: 17/600,737

(22) PCT Filed: May 20, 2020
(86) PCT No.: PCT/FR2020/050838

§ 371 Date: Oct. 1, 2021

(30) Foreign Application Priority Data
May 24, 2019 (FR) 1905514

(51) Int. Cl. F02C 7/22

(52) U.S. Cl. CPC F02C 7/22

(57) ABSTRACT

The invention relates to a fuel supply system of a turbomachine, including a fuel circuit having a pressurizing means at the outlet of the circuit, a pump arranged to send a flow of fuel into the circuit, and a flow sensor placed in a fuel supply duct between an outlet of the pump and the pressurizing means. The fuel circuit includes a device for regulating a flow cross section between the pump and the flow sensor, the device being activated by control means, the shaft of the pump being associated with detection means recording a speed of rotation of the shaft, and, if these detection means record a speed of rotation above a variable predetermined threshold, the regulating device is activated in order to reduce the flow sent to the flow sensor.

### TECHNICAL FIELD OF THE INVENTION

The present invention relates to a fuel supply system of a turbomachine with regulation of the fuel flow in the event of a failure of the drive of a fuel supply pump of the turbomachine then operating at overspeed, in order to ensure a fuel flow that is just right.

### TECHNICAL BACKGROUND

The prior art includes in particular the document EP 0 694 120 A1.

Taking the non-limiting case of aircraft turbomachines, in particular aircraft turbojet engines, these turbomachines are equipped with fuel regulation systems. These systems comprise a high-pressure main pump of the volumetric type delivering the fuel to the combustion chamber.

Alternatively, a centrifugal pump can also be used. What will now be described, however, relates to a positive displacement pump.

Referring to FIG. 1 representing the variations of flow F as a function of the speed of rotation ω of the motor axle of the turbomachine, the fuel requirement F1 varies in a non-linear way as a function of the regime of the turbomachine.

The speed of rotation ω of the motor axle of the turbomachine varies between a minimum value ωmin, for ignition of the turbomachine, and a maximum value ωmax for take-off. The regime corresponding to a cruise flight lies between these two extremes.

Depending on the application, the crucial point is located either at low-speed ignition or at high-speed take-off. In FIG. 1, this crucial point is located at the ignition level.

The displacement of the pump must be chosen in such a way that its linear characteristic is equal to the value K.Cyl1, in order to ensure sufficient flow under all flight conditions.

The reference K is the ratio of the speed of the pump to the axle speed of the turbojet engine and this ratio is multiplied with the values of the displacement of the pump in this FIG. 1.

This K.Cyl1 value can be significantly higher than the minimum K.Cylmin value required in certain flight conditions, or even the K.Cyl2 value required during take-off.

According to this dimensioning, the flow supplied by the pump follows the straight line L1 on the flow/speed of rotation diagram in FIG. 1. During a large phase of driving speed, in particular, in cruise flight, the pump therefore delivers a flow higher than the fuel flow required, and therefore a surplus F2 of fuel.

The hydromechanical unit must therefore return the excess fuel F2 to the pump, via a recirculation loop, in relation to the requirement.

This mode of operation induces a surplus of power to be drawn from the turbojet gearbox, a surplus of mechanical power which is transformed into thermal power dissipated in the recirculation loop.

The recirculation loop, a source of thermal rejection, has an impact on the surface area of the fuel/lubricating oil exchanger and must therefore be greatly reduced.

It has been proposed, in particular, in the document WO2018/138454, to eliminate this recirculation loop by controlling the speed of the pump in such a way as to adapt to the right need in terms of flow and pressure. This speed control is usually achieved by using electrical machines.

Referring to FIG. 2, this document discloses a fuel supply system for a turbomachine, comprising a fuel circuit with a pressurizing means 202 positioned in a fuel supply duct just upstream of the outlet 3 of said circuit provided with a shut-off valve.

A pump 1 is arranged to deliver into the circuit a fuel flow which is an increasing function of the speed of rotation of a shaft of the pump 1. The system delivers this amount of fuel at an outlet 3 for a turbomachine.

The pump 1 can be driven, directly or indirectly, by a motor 6 but also, alternatively, by two motors whose torque and speed are then controlled by the electrical power and frequency of the current sent by a converter dedicated to each of the motors, each of the converters being controlled by a control box.

The circuit comprises a flow sensor 201 placed in a fuel supply duct between an outlet of the pump 1 and the pressurizing means 202.

The flow sensor 201 comprises a sliding drawer 211, a return means 206 and a sensor 212 for the position of said drawer, this position sensor being advantageously a passive inductive electrical sensor of linear displacements, known by the acronym LVDT meaning “Linear Variable Differential Transformer”.

The position of the drawer 211 is controlled by a pressure difference across the flow sensor 201 shaped to compensate for the force applied by the return means 206 on said drawer 211, the circuit being arranged so that the position of said drawer 211 indicates an injected fuel flow passing through the flow sensor 201.

There is provided a means 7 of feeding fuel to the pump 1, advantageously a second pump which is a low-pressure pump, from a fuel tank 8. A hydromechanical group is defined as comprising the flow sensor 201 with its dedicated elements 206, 211, 212, the pressurizing means 202 with its shut-off valve, a control servo valve 204 and a recirculation valve 203. The fuel feed system is also connected to variable geometries actuators 10. To this end, the fuel circuit advantageously comprises a tapping on the outlet pipe of the pump 1 to supply a control loop for the actuators of variable geometries 10 and incorporating a filtration system 205 through which the supply to the variable geometries 10 and all the control circuits pass. The tapping is placed between the pump 1 and the flow sensor 201 of the hydromechanical unit. A fuel recirculation loop 5 returns used fuel from the variable geometries 10 to the pump 1 as well as the cooling flows of these variable geometries.

The servo valve 204 controls the pressurizing means 202 and the recirculation valve 203. The pressurizing means 202 remains necessary to ensure the minimum pressure for the correct operation of the variable geometries 10, as well as to ensure the cut-off of the injected flow.

When this cut-off is activated by the servo valve 204 controlling the recirculation valve 203, the flow delivered by the pump 1, advantageously volumetric, must be exhausted so as not to increase the pressure in the circuit.

Thus, the recirculation valve 203 is added to ensure this recirculation for the time it takes for the speed of rotation of the pump to decrease. This recirculation will only exist during the stop phase or during the preparation for ignition.

At the ignition, the pump will be driven at minimum speed of rotation. Some of the flow will pass through the flow sensor 201 and be recirculated through the recirculation valve 203.

The speed of rotation of the pump 1 will then be adjusted to achieve the correct setpoint ignition flow. The servo valve 204 will then be activated, which will lead to the opening of the shut-off valve associated with the pressurizing means 202, the closing of the recirculation valve 203 and thus allow the injection of the ignition flow.

Finally, the recirculation valve 203 will provide protection in case of overspeed due to a failure of the control of the speed of the pump.

In the event of a flow demand related to the variable geometries 10, at a given speed of rotation, the flow sensor 201 will tend to close, forcing the drive assembly to accelerate in order to maintain the correct injected flow requested.

The monitoring loop, based on the position of the flow sensor, therefore allows for a suitable pump speed for any operating point, whether the variable geometries are active or not.

In such a system, the speed of rotation of the pump is adapted to the need and it is no longer necessary to set up a fuel recirculation loop, hence the possibility of eliminating a regulating valve provided for in an earlier prior art.

It is therefore possible, for example, to imagine a solution where an electric motor directly drives the pump at the desired speed. In such a case, which may also be the case for other forms of pump drive, there is a possibility of a failure of the motor control resulting in the application of the maximum speed to the pump. In this case, without a particular system, the injected flow would be too high and lead to overspeed.

As previously stated, the flow is the image of the speed of rotation. In case of a control failure of the pump motor leading to a too high or even maximum rotation of the shaft of the pump, it becomes impossible to control the metered flow and it will have to be switched off.

With regard to the failure rate of the control, it would be desirable to have a device in place to ensure correct operation in the event of a malfunction of the pump drive.

Therefore, the problem underlying the invention is, in a fuel supply system of a turbomachine, comprising a pump arranged to send a flow of fuel into the system by rotation of its shaft at a controlled speed, to accurately meter the amount of fuel at the output of the system even in the event of a malfunction for which the shaft of the pump rotates at a speed which is too fast and not desired.

### SUMMARY OF THE INVENTION

The present invention relates to a fuel supply system for a turbomachine, comprising a fuel circuit comprising pressurizing means at the outlet of said circuit, a pump arranged to send a flow of fuel into said circuit which is an increasing function of the speed of rotation of a shaft of the pump, the circuit comprising a flow sensor placed in a fuel supply duct between an outlet of the pump and the pressurizing means, the flow sensor comprising a sliding drawer, a return means and a sensor for the position of said drawer, the position of said drawer being controlled by a pressure difference across the terminals of the flow sensor shaped to compensate for the force applied by the return means on said drawer, the circuit being arranged so that the position of said drawer indicates an injected fuel flow passing through the flow sensor, characterised in that the fuel circuit comprises a device for regulating a passage cross section between the pump and the flow sensor and activated by control means, the shaft of the pump being associated with detection means recording a speed of rotation of the shaft and, if these detection means record a speed of rotation above a variable predetermined threshold, the regulating device is configured to be activated to reduce and meter the injected fuel flow sent to the flow sensor.

Without limitation, the device for regulating a passage cross section between the pump and the flow sensor may be a double stage servo valve, a single stage servo valve or a drawer and bush assembly. The variable predetermined threshold is a threshold above a setpoint speed of rotation of the shaft, depending in particular on the fuel flow to be injected. This threshold depends on the operating conditions of the turbomachine.

The purpose of the present invention is to avoid the flow of excess fuel sent to the outlet of the supply system when the shaft of the pump rotates in overspeed compared to the speed corresponding to a desired fuel flow, thus during a malfunction of the drive of the pump leading to an overspeed rotation of the shaft of the pump.

This makes it possible to complete the regulation of the fuel flow by the just-in-time supply system as proposed in the prior art, which was however inoperative during such a malfunction leading to an overspeed of the shaft of the pump.

In normal operation, when the shaft of the pump is rotating at a speed corresponding to the flow of the desired fuel to be injected, no current is sent to the regulating device. The regulating device is then inoperative so that there is no fuel flow through it or so that the regulating device does not create a pressure drop in the fuel supply duct by varying the passage cross-section.

As soon as an overspeed of the shaft of the pump is recorded, the regulating device is activated and can perform a reduction of the injected fuel flow sent to the flow sensor of the circuit.

In case of detection of the failure resulting in an undesired maximum speed of rotation of the shaft of the pump, the regulating device is supplied.

Depending on the current sent to the regulating device and the gain of the regulating device, it is thus possible to control the flow through it, which is subtracted from the pumped flow, or to perform a change in the passage cross section through the regulating device.

Thus, despite the high speed of the pump, it is possible to continue to meter the injected fuel flow with the same level of precision as in normal operation. The case of a failure with overspeed of the shaft of the pump is thus well dealt with, without degrading the normal operation of the system.

Advantageously, the supply system comprises a monitoring unit determining a setpoint flow to be injected from the pump to the flow sensor and integrating the means for controlling the regulating device, the variable predetermined threshold being a function of the setpoint flow, the means for controlling the regulating device regulating the flow of fuel to the flow sensor to obtain a flow injected into the flow sensor according to the setpoint flow.

In a first embodiment of the present invention, the regulating device is positioned in a bypass of the flow sensor in a first bypass to the fuel supply duct, the regulating device being, when activated, supplied with a fuel flow subtracted from the injected flow sent to the flow sensor.

In normal operation, the pressure at the inlet of the flow sensor is adapted by controlling the speed of the pump, being a positive displacement pump, according to the desired position of the flow sensor. The regulating device is controlled to full closure so that the fuel flow to the flow sensor is not reduced.

When an undesired overspeed of the shaft of the pump rotation is detected, the regulating device is opened and takes a flow subtracted from the flow exiting of the pump toward the flow sensor. Advantageously, the opening of the regulating device is adjustable so that the subtracted flow is more or less quantifiably large.

Advantageously, the fuel of the subtracted flow is returned to the pump by a first recirculation loop connecting the regulating device to the pump.

In a second embodiment of the present invention, the regulating device is positioned in series with the flow sensor in the supply duct, the regulating device creating, upon its activation, a pressure drop in the supply duct reducing the injected fuel flow sent to the flow sensor, the pump being a high pressure centrifugal pump.

A variation in the passage cross-section via the regulating device is thus created upstream of the flow sensor, in order to adapt the permeability of the circuit downstream of the centrifugal pump. The closing of the regulating device narrowing the passage cross- section is advantageously adjustable so that the flow to the flow sensor is more or less important.

In normal operation, the pressure at the inlet of the flow sensor is adapted by controlling the speed of the centrifugal pump according to the desired position of the flow sensor. The regulating device is controlled at full opening so as to minimise the narrowing of the passage.

Advantageously, the fuel circuit comprises a control loop intended to operate variable geometries of the turbomachine, said control loop starting by tapping a second bypass placed upstream of the first bypass or the regulating device on the supply duct at the outlet of the pump, a second recirculation loop of fuel returning to the pump from the variable geometries.

When the variable geometries are actuated, the flow sensor and, if applicable, the regulating device, located after the second bypass of the variable geometries, experience a drop in flow, which may require the control means of the drive device to increase the speed of the pump to increase the flow in order to supply the injection chamber and maintain the pressure in the supply duct, cooperating for this purpose with the pressurisation valve.

In this case, it is possible that the speed of the shaft of the pump no longer corresponds to an overspeed and the subtraction of flow or a passage restriction effected by the regulating device can be reduced by reducing the opening of the regulating device in the first embodiment of the invention or increasing the opening of the regulating device in the second embodiment of the invention.

Advantageously, the regulating device is a double-stage servo valve or associated with a directional valve.

Advantageously, if the detection means detect a speed of rotation below the predetermined threshold, the regulating device is not activated and the subtracted flow is zero or a flow reduction sent to the flow sensor is zero.

Advantageously, a recirculation valve is placed in bypass between the flow sensor and the pressurizing means, being connected to a third recirculation loop, an auxiliary regulating device essentially controlling the pressurizing means and the recirculation valve, the first, second and third recirculation loops joining at the pump inlet.

The invention also relates to a turbomachine comprising such a supply system.

Finally, the invention relates to a method of regulating a injected flow of fuel from a fuel pump to a flow sensor placed in a fuel supply duct of a fuel supply system of such a turbomachine in an aircraft, the method implementing laws for controlling the speed of rotation of the shaft of the pump, which increase or, respectively, decrease this speed when the flow indicated by the flow sensor decreases or increases, so that the flow and the pressure at the outlet of the circuit follow setpoint values adapted to the flight conditions of the aircraft, characterised in that, when a speed of rotation of the shaft of the pump is detected as indicative of a malfunction of a drive of the shaft and is too high with respect to the predetermined variable setpoint threshold values, a reduction in the injected fuel flow sent from the pump to the flow sensor is performed.

The methods disclosed in the closest prior art allowed to accurately and quickly regulate a supply system with a controlled fuel circuit whose pump was driven as required.

However, it became clear that the failure rate of the drive with overspeed of rotation of the shaft of the pump could question the use of such processes according to the prior art.

It therefore became necessary to implement a solution that would allow to eliminate this blocking failure case, without questioning the use of the fuel circuit as required, in order to reduce the power consumed by the circuit as much as possible.

This is precisely what the present invention allows by implementing such a fuel supply system and such a regulation method, while maintaining regulation processing in normal operation with a speed of rotation of the shaft in accordance with the control laws.

This removes a major obstacle to the use of a fuel system as requested according to the prior art by covering a handicapping failure case, without degrading the performance of the control system under other conditions.

### BRIEF DESCRIPTION OF THE FIGURES

Other features, purposes and advantages of the present invention will become apparent from the following detailed description and from the attached drawings, which are given as non-limiting examples and in which:

FIG. 1 shows a speed and flow diagram showing the discrepancy between the flow supplied by the fuel pump and the requirement for a fuel supply system of a turbomachine in an aircraft,

FIG. 2 is a schematic representation of a fuel supply system for a turbomachine according to the prior art,

FIG. 3 is a schematic representation of a fuel supply system of a turbomachine according to a first embodiment according to the present invention,

FIG. 4 is a schematic representation of a fuel supply system of a turbomachine according to a second embodiment according to the present invention.

It should be borne in mind that the figures are given as examples and are not limiting the invention. They constitute schematic representations of principle intended to facilitate the understanding of the invention and are not necessarily on the scale of practical applications. In particular, the dimensions of the various elements illustrated are not representative of reality.

### DETAILED DESCRIPTION OF THE INVENTION

In what follows, reference is made to all the figures and in particular to FIGS. 2 to 4 taken in combination. Where reference is made to a specific figure or figures, these figures are to be taken in combination with the other figures for the recognition of the designated numerical references.

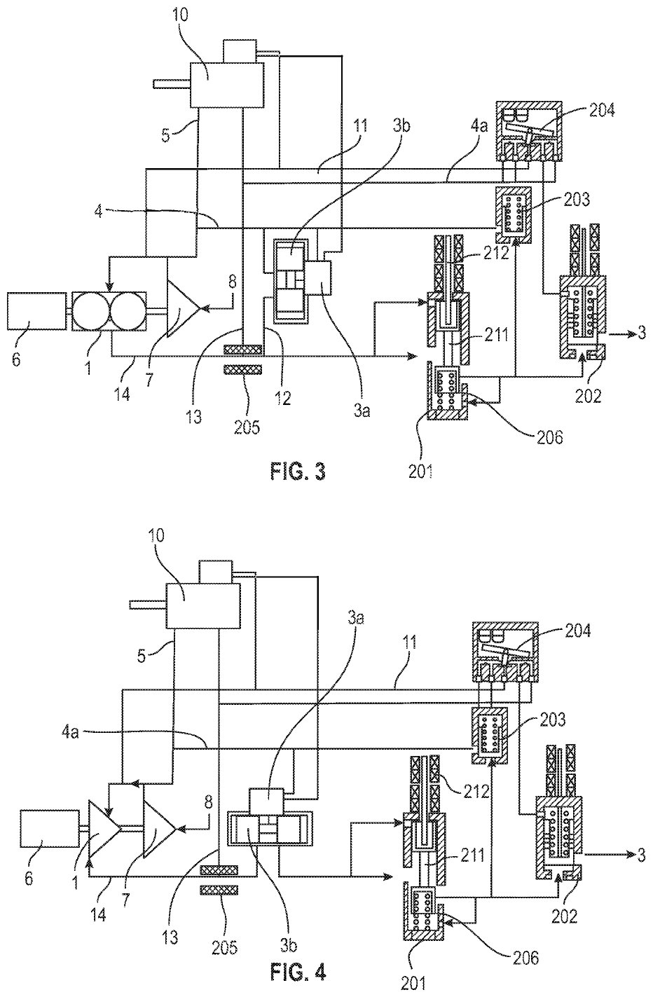

Referring principally to FIGS. 3 and 4 which show two embodiments of a fuel supply system for a turbomachine, but also to what has been stated previously with respect to FIG. 2 relating to a supply system according to the prior art for the elements which are common to the systems of FIGS. 2 to 4, the present invention relates to a fuel supply system for a turbomachine.

The system comprises a fuel circuit comprising a pressurizing means 202 at the outlet 3 of said circuit, a pump 1 arranged to send into said circuit a fuel flow which is an increasing function of the speed of rotation of a shaft of the pump 1.

The circuit of the system comprises a flow sensor 201 placed in a fuel supply duct 14 between an outlet of the pump 1 and the pressurizing means 202. The flow sensor 201 comprises a sliding drawer 211, a return means 206 and a position sensor 212 of said drawer.

The position of said drawer 211 is controlled by a pressure difference across the flow sensor 201 shaped to compensate for the force applied by the return means 206 on said drawer 211.

The circuit is arranged so that the position of said drawer 211 indicates an injected fuel flow passing through the flow sensor 201.

All these features are common to the system according to the prior art and to the system according to the embodiments of the present invention.

In order to prevent the pump 1 from delivering an undesired excess of fuel into the system, when its shaft rotates at an undesired high speed and not in correspondence with a setpoint of fuel to be injected to the flow sensor 201, this due to a malfunction of the pump 1 and its drive device 6, the fuel circuit comprises a device for regulating 3a, 3b a passage cross-section between the pump 1 and the flow sensor 201 and activated by control means.

In FIGS. 3 and 4, reference 3a illustrates a regulating device which may be a servo valve and the reference 3b illustrates an actuator which may be a second servo valve stage or a drawer/lock assembly. This is not limiting for the purpose of the present invention. The shaft of the pump 1 is associated with detection means recording a speed of rotation of the shaft. If or as soon as these detection means detect a speed of rotation above a variable predetermined threshold, the regulating device 3a, 3b is activated to reduce the injected fuel flow sent to the flow sensor 201.

The variable predetermined threshold may be a function of a setpoint fuel flow to be sent through the fuel circuit to the flow sensor 201. This setpoint flow is dependent on a speed of rotation of the turbomachine and operating conditions, for example a start-up, acceleration or deceleration of the turbomachine.

The supply system may then comprise a monitoring unit, not shown in the figures, comprising means for determining a setpoint flow to be injected from the pump 1 to the flow sensor 201 and integrating the means for controlling the regulating device 3a, 3b.

The control of the regulating device 3a, 3b can be carried out on the basis of the flow indication given by the position sensor 212 of the drawer of the flow sensor 201. This setpoint flow is dependent on a speed of rotation of the turbomachine and operating conditions, for example a start-up, an acceleration or deceleration of the turbomachine.

The monitoring unit may comprise a microprocessor with means for storing the variable predetermined threshold and be connected to a monitoring unit of the turbomachine by being integrated in this monitoring unit of the turbomachine.

The means for controlling the regulating device 3a, 3b may regulate the fuel flow to the flow sensor 201 to obtain a flow injected into the flow sensor 201 as a function of the setpoint flow.

Two embodiments of the present invention will now be described. These embodiments are not limiting of the present invention.

In a first embodiment of the present invention, as shown in FIG. 3, the regulating device 3a, 3b may be positioned in a bypass of the flow sensor 201 in a first bypass 12 or led in bypass 12 to the fuel supply duct 14.

In this optional configuration, the regulating device 3a, 3b may, upon activation, be supplied with a flow of fuel subtracted from the injected flow supplied to the flow sensor 201, the fuel of the subtracted flow passing through the bypass conduit 12.

The fuel of the subtracted flow can be returned to the pump 1 at the outlet of the regulating device 3a, 3b through a first recirculation loop 4 connecting the regulating device 3a, 3b to the pump 1.

In a second embodiment of the present invention, as shown in FIG. 4, the regulating device 3a, 3b may be positioned in series with the flow sensor 201 in the fuel supply duct 14.

In this optional configuration, the regulating device 3a, 3b may create, upon activation, a narrowing of the passageway in the fuel supply duct 14 reducing the injected fuel flow sent to the flow sensor 201.

In this second embodiment, the pump 1 is advantageously a high pressure centrifugal pump.

In the event of a failure of the drive assembly, bringing it to an undesired maximum speed or overspeed, the centrifugal pump 1 will make too much pressure upstream of the flow sensor 201, which will render the control laws of the injected flow inoperative.

The detection of this failure will cause the regulating device 3a, 3b or a single stage or double stage servo valve assembly 3a, 3b in conjunction with a directional valve to create a flow variation toward the flow sensor 201.

By modulating the permeability of the circuit downstream of the centrifugal pump 1 and upstream of the flow sensor 201, the use of the regulation of the fuel circuit will thus always be guaranteed, even during this type of failure.

There may be at least two types of pump 1 that can be used in the context of the present invention, namely either a positive displacement pump 1, for example a gear pump 1, or a centrifugal pump 1.

For any type of pump 1, it is possible to interpose a low-pressure pump 7 between the pump 1 and the fuel tank 8.

Although not shown in the figures, a positive displacement pump 1 may be driven by an outlet shaft of an accessory gearbox of the turbomachine, which in turn is driven by a shaft of the primary body of the turbomachine.

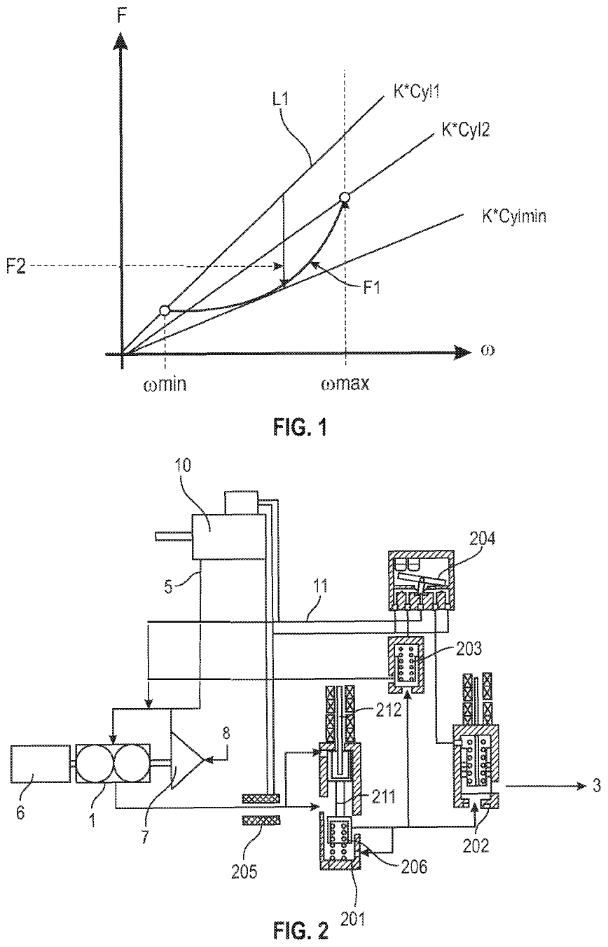

A drive device may be generally installed between the shaft of the accessory relay gearbox and the pump 1 to match the regimes of rotation between these two pieces of equipment and to determine the ratio K previously mentioned with respect to FIG. 1 between the speed of the pump 1 and the speed of rotation co of the motor axle of the turbomachine.

An epicyclic reduction gear may be used in the drive device, comprising a central planetary gear rotating about the axle of the gear, planet gears meshing with the central planetary gear and carried by a planet carrier, the planet carrier being arranged to be rotatable about the axle of the gear.

The epicyclic gear may also comprise an outer ring gear with which the planet gears also mesh, the ring gear being arranged to be rotatable about the axle of the gear.

The regulating device 3a, 3b may be a single stage servo valve, a double stage servo valve or a servo valve associated with a directional valve and being single stage. The position of the servo valve in the circuit may be different depending on whether the pump is positive displacement or centrifugal.

In the case where the detection means record a speed of rotation lower than the predetermined threshold, which corresponds to a drive of the pump 1 without malfunction, the regulating device 3a, 3b is not activated.

In this case, the subtracted flow according to the first embodiment is zero or a flow reduction sent to the flow sensor 201 according to the second embodiment is zero.

In both embodiments of the present invention, the fuel circuit may comprise a control loop 13, 5 intended to operate variable geometries 10 of the turbomachine. The control loop 13, 5 may start by tapping a second bypass 13 placed upstream of the regulating device 3a, 3b on the supply duct 14 at the outlet of the pump 1. A second fuel recirculation loop 5 can then return to the pump 1 from the variable geometries 10.

In analogy to a system according to the prior art, in the present invention, a recirculation valve 203 may be placed in bypass between the flow sensor 201 and the pressurizing means 202, being connected to a third recirculation loop 4a.

The first, second and third recirculation loops 4, 5, 4a may join at the inlet of the pump 1.

It should be borne in mind that other forms of return to the pump 1 can be implemented and that what is shown in the figures is purely illustrative and not limiting. For example, loops may be communalised or returned to other positions in the fuel circuit. An auxiliary regulating device 204, for example in the form of a servo valve and different from the above regulating device, may control essentially the pressurizing means 202 and the recirculation valve 203. Although this is not limiting, a fourth recirculation loop 11 may also be present starting from the auxiliary regulating device 204 and opening into the pump 1 by joining the first, second and third recirculation loops 4, 5, 4a upstream of the pump 1.

The pressurizing means 202 ensures the minimum pressure for the correct operation of the variable geometries 10, as well as the cut-off of the injected flow.

The recirculation valve 203 ensures that the flow delivered by the pump 1 is exhausted so that the pressure in the circuit does not rise when the auxiliary regulating device 204 activates this cut-off.

However, this recirculation only exists during the shutdown phase or during the preparation for ignition, while the speed of rotation of the pump 1 is reduced.

The invention also relates to a turbomachine comprising such a feed system.

Finally, the invention relates to a method of regulating an injected flow of fuel from a fuel pump 1 to a flow sensor 201 placed in a fuel supply duct 14 of a fuel supply system of such a turbomachine in an aircraft, then at the outlet 3 of the system to the turbomachine.

The method implements laws for controlling the speed of rotation of the shaft of the pump 1, which increase or, respectively, decrease this speed when the flow indicated by the sensor decreases or increases, so that the flow and the pressure at the outlet of the circuit follow setpoint values adapted to the flight conditions of the aircraft. These control laws can be implemented in the monitoring unit of the fuel system.

According to the invention, when it is detected that the significant speed of rotation of the shaft of the pump 1 is too high with respect to the current setpoint values delivered in accordance with the control laws by the monitoring unit of the system, the injected fuel flow sent from the pump 1 to the flow sensor 201 is reduced.

This flow reduction can be done by subtracting a flow through the regulating device 3a, 3b or by the narrowing of the passage in the supply duct 14 under the action of the regulating device 3a, 3b which can then be integrated as a servo valve in the supply duct 14.

The invention is by no means limited to the described and illustrated embodiments, which have been given only as examples.

1. A fuel supply system of a turbomachine, comprising a fuel circuit comprising pressurizing means at the outlet of said circuit, a pump arranged to send a flow of fuel into said circuit which is an increasing function of the speed of rotation of a shaft of the pump, the circuit comprising a flow sensor placed in a fuel supply duct between an outlet of the pump and the pressurizing means, the flow sensor comprising a sliding drawer, a return means and a sensor for the position of said drawer, the position of said drawer being controlled by a pressure difference across the terminals of the flow sensor shaped to compensate for the force applied by the return means on said drawer, the circuit being arranged so that the position of said drawer indicates an injected fuel flow passing through the flow sensor, wherein the fuel circuit comprises a device for regulating a passage cross section between the pump and the flow sensor, and activated by control means, the shaft of the pump being associated with detection means recording a speed of rotation of the shaft and, if these detection means record a speed of rotation above a variable predetermined threshold, the regulating device is configured to be activated to reduce and meter the injected fuel flow sent to the flow sensor.

2. The supply system according to claim 1 which comprises a monitoring unit determining a setpoint flow to be injected from the pump to the flow sensor and integrating the means for controlling the regulating device, the variable predetermined threshold being a function of the setpoint flow, the means for controlling the regulating device regulating the flow of fuel to the flow sensor to obtain a flow injected into the flow sensor according to the setpoint flow.

3. The supply system according to claim 1, wherein the regulating device is positioned in a bypass of the flow sensor in a first bypass to the fuel supply duct, the regulating device being, when activated, supplied with a fuel flow subtracted from the injected flow sent to the flow sensor.

4. The supply system according to claim 3 wherein the fuel of the subtracted flow is returned to the pump by a first recirculation loop connecting the regulating device to the pump.

5. The supply system according to claim 1, wherein the regulating device is positioned in series with the flow sensor in the supply duct, the regulating device creating, upon activation, a narrowing of the passage in the fuel supply duct reducing the injected fuel flow sent to the flow sensor, the pump being a high pressure centrifugal pump.

6. The supply system according to claim 1, wherein the fuel circuit comprises a control loop intended to operate variable geometries of the turbomachine, said control loop starting by tapping a second bypass placed upstream of the first bypass or of the regulating device on the supply duct at the outlet of the pump, a second recirculation loop of fuel returning to the pump from the variable geometries.

7. The system according to claim 1, wherein the regulating device is a single stage servo valve, a double stage servo valve or associated with a directional valve.

8. The system according to claim 1, wherein, if the detection means record a speed of rotation below the predetermined threshold, the regulating device is not activated and the subtracted flow is zero or a flow reduction sent to the flow sensor is zero.

9. The supply system according to claim 8, wherein a recirculation valve is placed in bypass between the flow sensor and the pressurizing means, being connected to a third recirculation loop, an auxiliary regulating device essentially controlling the pressurizing means and the recirculation valve, the first, second and third recirculation loops joining at the inlet of the pump.

10. A turbomachine comprising a supply system according to claim 1.

11. A method of regulating an injected flow of fuel from a fuel pump to a flow sensor placed in a fuel supply duct of a fuel supply system of a turbomachine according to the preceding claim in an aircraft, the method implementing laws for controlling the speed of rotation of the shaft of the pump, which increase or, respectively, decrease this speed when the flow indicated by the flow sensor decreases or increases, so that the flow and the pressure at the outlet of the circuit follow setpoint values adapted to the flight conditions of the aircraft, characterised in that, when a speed of rotation of the shaft of the pump is detected as being significant of a malfunction of a drive of the shaft and being too high with respect to the predetermined variable setpoint threshold values, a reduction in the injected fuel flow sent from the pump to the flow sensor is performed.
